(19) United States
(12) Patent Application Publication
(10) Pub. No.: US 2006/0261136 A1
(43) Pub. Date: Nov. 23, 2006

(54) Diffusion bonding method for forming metal substrate

(75) Inventor: Akio Sano, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/434,228

(22) Filed: May 16, 2006

(30) Foreign Application Priority Data
May 17, 2005 (JP) 2005-143505

(51) Int. Cl. B23K 20/00; B23K 35/38

(52) U.S. Cl. 228/193; 228/219

(57) ABSTRACT

A metal substrate has a honeycomb structure made of aluminum-containing stainless steel and a metal external cylinder containing the honeycomb structure. The honeycomb structure is formed by a first corrugated plate and one of a flat plate and a second corrugated plate in a pitch shorter than the first corrugated plate, stacked on each other. The metal substrate is placed in a heat chamber of a heat treatment furnace. An inert gas is supplied into the heat chamber, and the metal substrate is heated at a diffusion bonding temperature. During this heat treatment process, the inert gas is kept being supplied to the heat chamber through an inlet port of the heat treatment furnace and discharged through its outlet port so that the inert gas can blow off a nitrogen gas emitted from the external cylinder of the metal substrate.

### BACKGROUND OF THE INVENTION

1. Field of the Invention

The present invention relates to a diffusion bonding method for forming a metal substrate that carries a catalyst for purifying an exhaust gas discharged from an internal combustion engine of a vehicle, a boiler, combustion equipment, or the like.

2. Description of the Related Art

A metal substrate carries a catalyst for purifying an exhaust gas discharged from an internal combustion engine mounted on a motor vehicle or others. In order to improve its gas purification performance, the metal substrate has a honeycomb structure carrying the catalyst on its surface and contained in an external cylinder. The honeycomb structure is made of aluminum-containing stainless steel. It includes a long pitch corrugated plate and one of a flat plate and a short pitch corrugated plate are stacked on each other to form a plurality of honeycomb passages (cell passages) through which an exhaust gas can pass. The honeycomb structure thus constructed is inserted into the external cylinder made of ferritic stainless steel, and then they are diffusion-bonded in a heat treatment furnace under high vacuum as disclosed in Japanese Patent Laid-open No. (Tokkai Hei) 9-99218, or in a highly charged inert gas as disclosed in Japanese Patent Laid-open No. (Tokkai Hei) 2-182333.

In these conventional diffusion bonding methods, usage of the high vacuum or the highly charged inert gas is intended to prevent formation of an aluminum oxide layer, which is developed on a surface portion of the honeycomb structure by a chemical reaction of the aluminum in/on the honeycomb structure and a micro oxygen in a heating atmosphere to obstruct mutual diffusion of their atoms between them.

The above known conventional diffusion bonding methods, however, encounter a problem in that some contacting portions of the honeycomb structure and the external cylinder are not diffusion-bondable with each other, specifically at a surface portion formed with an aluminum nitride layer. This aluminum nitride is formed by a chemical reaction of the aluminum contained in the honeycomb structure and a nitrogen gas emitted from the external cylinder in a heat treatment process, because no flow of gas, such as the inert gas, in the heat treatment furnace allows the nitrogen gas to remain on and/or around the metal structure during the heat treatment process.

The external cylinder massively absorbs the nitrogen gas included in the air around the metal structure before it is placed in the vacuumed or insert-gas filled heat treatment furnace.

As shown in FIG. 6, in these diffusion bonding methods, the external cylinder is heated in an argon gas by the heat treatment furnace to rise its temperature T up to a diffusion bonding temperature Td, which is set to be more than approximately 1000 degrees C., as heating time t advances. In an area DN, indicate by an ellipse in FIG. 6, at temperatures of approximately 500 degrees C. to approximately 600 degrees C. before reaching the diffusion bonding temperature Td, the nitrogen gas absorbed in the external cylinder is emitted therefrom. This emitted nitrogen gas is suspended around a surface of the metal substrate and reacts with aluminum component contained in the honeycomb structure to form the aluminum nitride layer on its surface, which obstructs the mutual diffusion of their atoms between the external cylinder and the honeycomb structure.

It is, therefore, an object of the present invention to provide a diffusion bonding method, for forming a metal substrate, which overcomes the foregoing drawback and can prevent defective joint of a metal external cylinder and a honeycomb structure made of aluminum-containing stainless steel due to formation of an aluminum nitride layer generated by a chemical reaction of the aluminum in the honeycomb structure and a nitrogen gas emitted from the outer cylinder in their heat treatment process.

### SUMMARY OF THE INVENTION

According to a first aspect of the present invention, there is provided a diffusion bonding method for forming a metal substrate having a honeycomb structure made of aluminum-containing stainless steel and a metal external cylinder containing the honeycomb structure, the honeycomb structure being formed by a first corrugated plate and one of a flat plate and a second corrugated plate in a pitch shorter than the first corrugated plate which are stacked on each other into multi-layers. The diffusion bonding metal comprises placing the metal substrate in a heat chamber of a heat treatment furnace, supplying an inert gas into the heat chamber; and heating the metal substrate at a diffusion bonding temperature. The inert gas is substantially kept being supplied to the heat chamber through an inlet port of the heat treatment furnace and discharged through an outlet port thereof during a heat treatment process so that the inert gas can blow off a nitrogen gas emitted from the external cylinder of the metal substrate.

Therefore, the diffusion bonding method can prevent defective joint of the external cylinder and the honeycomb structure due to formation of an aluminum nitride layer generated by a chemical reaction of the aluminum in the honeycomb structure and a nitrogen gas emitted from the outer cylinder in their heat treatment process.

Preferably, the inlet port and the outlet port are arranged in co-axial with each other.

Therefore, the inert gas can effectively blow off the nitrogen gas emitted from the external cylinder by being flown along the metal substrate along its axial direction.

Preferably, the inert gas is controlled so that a flow rate of the inert gas that passes through the inlet port and a pressure of a gas that passes through the outlet port to be constant, respectively.

Therefore, the nitrogen gas emitted from the external cylinder can be certainly blown off.

Preferably, the inert gas that passes through one metal substrate is set to have a flow rate of no less than 1000 ml/min.

Therefore, the nitrogen gas emitted from the external cylinder can be certainly blown off.

Preferably, part of contacting portions of the honeycomb structure and the external cylinder is free from diffusion bonding.

Therefore, the metal substrate can be prevented from thermal fatigue failure at the part of the contacting portions when the metal substrate is exposed to high heat.

Preferably, the part of contacting portions is an exhaust-gas upstream side portion.

Therefore, the metal substrate can have a long service life when it is used for an exhaust system of a motor vehicle.

### BRIEF DESCRIPTION OF THE DRAWINGS

The objects, features and advantages of the present invention will become apparent as the description proceeds when taken in conjunction with the accompanying drawings, in which:

FIG. 1 is a partially sectional perspective view showing a metal substrate manufactured by using a diffusion bonding method of a first embodiment according to the present invention;

FIG. 2 is a sectional side view showing the metal substrate manufactured by the diffusion bonding method of the first embodiment;

FIG. 3 is a partially sectional side view showing a heat treatment furnace containing the metal substrates in a heat treatment process of the diffusion bonding method of the first embodiment;

FIG. 4 is a partially sectional side view showing a heat treatment furnace containing metal substrates in a heat treatment process of a diffusion bonding method of a second embodiment according to the present invention;

FIG. 5 is a partially sectional side view showing a heat treatment furnace containing one metal substrate in a heat treatment process of a diffusion bonding method of a third embodiment according to the present invention; and

FIG. 6 is a time chart of the heat treatment process, showing a relationship between a temperature of the metal substrate and heating time and illustrating a range in which a nitrogen gas is emitted from the external cylinder.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

A diffusion bonding method, for forming a metal substrate, of a first embodiment according to the present invention will be described with reference to the accompanying drawings.

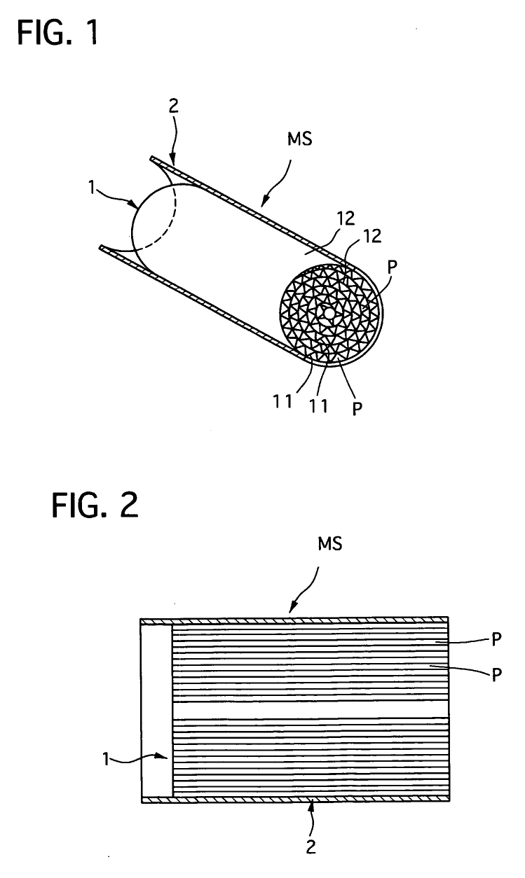

Referring to FIGS. 1 and 2, there is shown the metal substrate MS, which is manufactured by using the diffusion bonding method of the first embodiment.

The metal substrate MS is disposed, for example, in an exhaust gas system of a motor vehicle to carry a catalyst for purifying an exhaust gas discharged from an internal combustion engine.

The metal substrate MS includes a honeycomb structure 1 and an external cylinder 2 containing the honeycomb structure 1.

The honeycomb structure 1 has a long pitch corrugated plate 11 and a short pitch corrugated plate 12, which are made of stainless steel having a several dozen micrometer thickness and containing aluminum. The long and short pitch corrugated plates 11 and 12 are alternatively stacked on each other and rolled in multi-layers with the short pitch corrugated plate 12 being located at an outside to form a cylinder shape. The long pitch corrugated plate 11 corresponds to a first corrugated plate of the present invention, and the short pitch corrugated plate 12 corresponds to a second corrugated plate of the present invention.

These rolled corrugated plates 11 and 12 form a plurality of honeycomb passages (cell passages) P for flowing the exhaust gas therethrough. The honeycomb passages P constitute a part of the exhaust gas system connected with the internal combustion engine. Walls forming the honeycomb passages P are provided on their surfaces with a catalyst carrying layer, which is formed of alumina or others after a diffusion bonding process of the metal substrate MS. The catalyst carrying layer contains a metal catalyst, such as the alumina, which can purify Hydrocarbon (HC), Carbon Monoxide (CO), Nitrogen Oxide (NOx), and others in the exhaust gas while it passes through the honeycomb passages P.

The external cylinder 2 is made of ferritic stainless steel or the like. It has a thickness of 1 mm to 2 mm and is formed in a circular cylinder or a cylinder with a sectional shape like a race-track (a shape having half circles whose both ends are connected by two parallel lines).

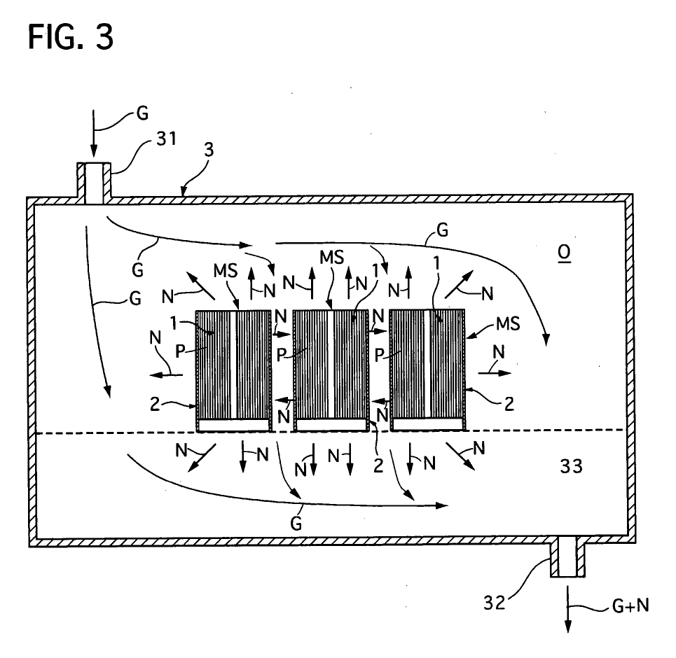

The honeycomb structure 1 is pressed into the external cylinder 2, and then they are diffusion-bonded at contacting portions between the long pitch corrugated plate 11 and the short pitch corrugated plate 12 and between the honeycomb structure 1 and the external cylinder 2 by using a heat treatment furnace 3 shown in FIG. 3.

This diffusion bonding process is carried out as follows.

As shown in FIG. 3, a plurality of metal substrates MS, three metal substrates in this embodiment, are located on a metal net 33 in the heat treatment furnace 3 to be heated at a diffusion bonding temperature of more than approximately 1100 degrees C., approximately 1300 degrees C. in this embodiment, under non-oxidative atmosphere, thereby diffusion-bonding the contacting portions between the long pitch corrugated plate 11 and the short pitch corrugated plate 12 and between the honeycomb structure 1 and the external cylinder 2.

The heat treatment furnace 3 is a closeable vessel with an inlet port 31 and an outlet port 32. The inlet port 31 and the outlet port 32 fluidically communicate with a heat chamber O formed inside the vessel. In the heat chamber O, the several metal substrates MS can be placed on the metal net 33, allowing an inert gas G such as an argon gas, a helium gas, or a neon gas to continuously pass through them. The inert gas G is supplied into the heat chamber O through the inlet port 31 and discharged through the outlet port 32, so that the insert gas G keeps pouring into/onto the metal substrates MS during the heat treatment process.

The inert gas G is regulated so as to substantially remove a nitrogen gas N contained therein before entering the heat chamber O. Specifically, its density in the inert gas G at the inlet port 31 is set to be equal to or less than 3 parts per million (ppm).

The flow rate of the inert gas G that passes through each metal substrate MS in the heat chamber O is set so that the inert gas G can certainly blow out the nitrogen gas N emitted from the external cylinders 2 of the metal substrates MS in the heat treatment process. Specifically, in this embodiment, the flow rate of the insert gas G supplied to each metal substrate MS is set to be equal to or more than 100 milliliters per minute (ml/min).

The inert gas G supplied through the inlet port 31 is controlled to have a constant flow rate, and a gas, mainly including the inert gas G and the nitrogen gas N emitted from the external cylinders 2, discharged through the outlet port 32 is also controlled to have a constant pressure, keeping a degree of vacuum necessary for diffusion bonding in the heat chamber O of the heat treatment furnace 3.

Note that the nitrogen gas N is emitted from outer surfaces, inner surfaces, and upper and lower surfaces of the external cylinders 2, but arrows indicating the nitrogen gas N emitted from the inner surfaces are omitted in FIG. 3 for facilitating visualization.

The operations and the advantages of the diffusion bonding method of the first embodiment will be described.

The long pitch corrugated plates 11 and the short pitch corrugated plates 12 are prepared. They are arranged alternatively and stacked on each other, then being rolled into multi-layers.

The honeycomb structure 1 consisting of the rolled corrugated plates 11 and 12 are pressed into the external cylinders 2 to form the metal substrates MS.

The metal substrates MS are brought into the heat chamber of the heat treatment furnace 3 through a not-shown door, and placed on the metal net 33, being apart from each other. The door is closed to seal up the heat chamber O against the outdoor air.

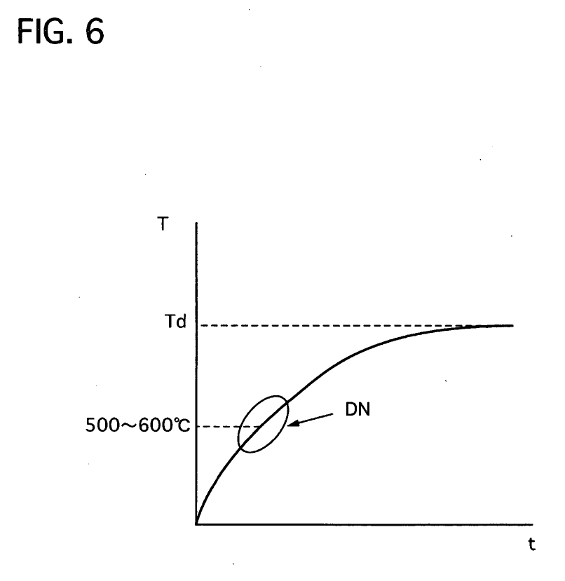

Then, the insert gas G starts to be supplied to the heat chamber O through the inlet port 31 and discharged through the outlet port 32. In addition, the heat treatment furnace 3 starts to heat up the metal substrates MS in the heat chamber O. As the temperature of the metal substrates MS rises with the heating time t in this heat treatment process, the external cylinder 2 starts to emit the nitrogen gas N, absorbed in it from the air, from their outer, inner, and upper and lower surface portions as shown in FIG. 3, at temperatures of approximately 500 degrees C. to approximately 600 degrees C. under the diffusion bonding temperature Td shown in FIG. 6.

In this heat treatment process, the inert gas G is kept being supplied to and discharged from the heat chamber O, which is kept at the degree of vacuum necessary for the diffusion bonding.

These emitted nitrogen gas N in the heat chamber O is blown out by the inert gas G through the outlet port 32. Accordingly, the Nitrogen gas N on/around the surface portions of the external cylinder 2 is sufficiently removed, so that no aluminum nitride layer is formed on the honeycomb structure 1.

When a temperature of the metal substrate MS reaches the diffusion bonding temperature Td of more than approximately 1000 degrees C., preferably 1300 degrees C., contacting portions of the external cylinder 2 and the short pitch corrugated plates 12, and contacting portions of the long pitch corrugated plates 11 and the short pitch corrugated plate 12 start to be diffusion-bonded. In this diffusion bonding process, the contacting portions are certainly joined with each other, because no aluminum nitride layer is generated on the surface of the contacting portions.

Therefore, the diffusion bonding method of the first embodiment can prevent the external cylinder 2 and the honeycomb structure 1 from their poor joining due to the aluminum nitride.

Next, a diffusion bonding method, for forming a metal substrate, of a second embodiment according to the present invention will be described with reference to the accompanying drawing.

In this second embodiment, a metal substrate MS to be diffusion-bonded has a construction similar to that of the first embodiment shown in FIGS. 1 and 2.

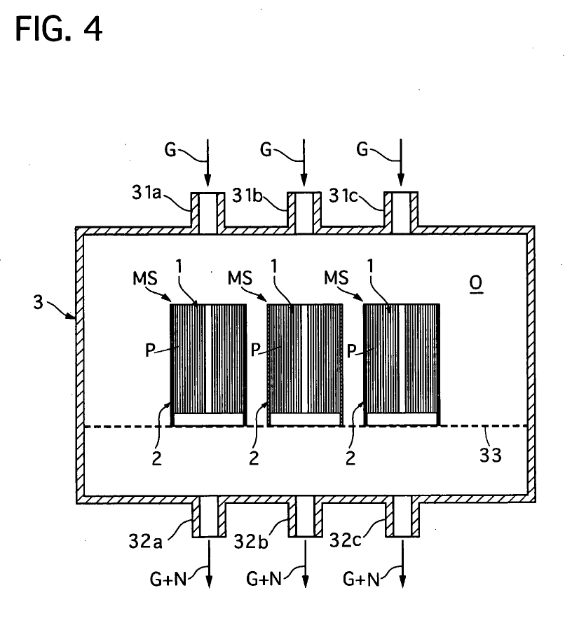

As shown in FIG. 4, a heat treatment furnace 3 has a heat chamber O, first to third inlet ports 31a to 31c and first to third outlet ports 32a to 32c. The number of the inlet ports 31 and outlet ports 32 is set to be the same one of the metal substrates MS which can be placed on a metal net 33 in a heat treatment process. The first inlet port 31a and the first outlet port 31a, the second inlet port 31b and the second outlet port 32b, and the third inlet port 31c and the third outlet port 32c are arranged coaxially with each other, respectively. They are arranged at places, where the metal substrates MS placed on the metal net 33 do not contact with each other.

Three metal substrates MS to be diffusion-bonded are placed on the metal net 33 so that they can be in coaxial with the first inlet and outlet ports 31a and 31b, the second inlet and outlet ports 31b and 31b, and the third inlet and outlet ports 31c and 31c, respectively.

An inert gas G is supplied to a heat chamber O through the first to third inlet ports 31a to 31c so as to be poured on the three metal substrates MS, and then discharged through the first to third outlet ports 32a and 32c, keeping the heat chamber O under vacuum.

The other parts of the heat treatment furnace 3 are constructed similarly to those of the first embodiment shown in FIG. 3.

In this second embodiment, the three metal substrates MS to be diffusion-bonded are placed on the metal net 33, apart from each other so that the inert gas G can flow a space formed between the adjacent metal substrates MS in order to blow off nitrogen gas N emitted from all surface portions of the metal substrates MS. With supplying the inert gas G, the metal substrates MS is heated up to a diffusion bonding temperature so that contacting portions of an external cylinder 2 and a short pitch corrugated plate, and contacting portions of the short pitch corrugated plate and a long pitch corrugated plate can be joined with each other.

The diffusion bonding method, using the above-constructed heat treatment furnace 3 shown in FIG. 4, of the second embodiment can improve a blowing-off efficiency of the nitrogen gas N due to an coaxial arrangement of the inlet ports 31a to 31c, the outlet ports 32a to 32c and the metal substrates MS. In particular, the nitrogen gas N emitted from an inner surface portion of the external cylinder 2 and an outer surface portion of a honeycomb structure 1 in a heat treatment process can be easily and certainly blown off from the heat chamber O.

Next, a diffusion bonding method, for forming a metal substrate, of a third embodiment according to the present invention will be described with reference to the accompanying drawing.

In this third embodiment, a metal substrate MS to be diffusion-bonded has a construction similar to that of the first embodiment shown in FIGS. 1 and 2.

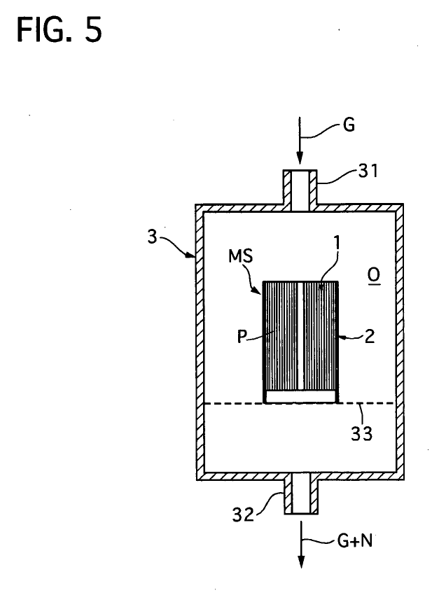

As shown in FIG. 5, a heat treatment furnace 3 is provided only for one metal substrate MS, where its inlet port 31 and outlet port 32 are arranged in coaxial with each other so as to flow the inert gas G in the same direction as that of an exhaust gas flow in the metal substrate MS when it is mounted on a motor vehicle. The other parts of a heat treatment furnace 3 are similar to those of the first embodiment shown in FIG. 3.

The diffusion bonding method, using the above-constructed heat treatment furnace 3, of the second embodiment can certainly blow off a nitrogen gas N emitted from the external cylinder 2.

Next, a diffusion bonding method, for forming a metal substrate, of a fourth embodiment according to the present invention will be described.

A metal substrate to be diffusion-bonded has a construction similar to that of the first embodiment shown in FIGS. 1 and 2, and a heat treatment furnace similar to that shown in FIG. 3, FIG. 4 or FIG. 5 is used for diffusion bonding of the metal substrate.

In this fourth embodiment, only part of contacting portions of a honeycomb structure and an external cylinder is diffusion-bonded.

When a catalyst converter with the metal substrate is disposed near a place with high temperature, just beneath an exhaust manifold connected with an engine for example, upstream side contacting portions of the honeycomb structure and the external cylinder are not joined in order to decrease thermal stress caused between them.

Specifically, the metal substrate is exposed to a high temperature exhaust gas when the engine starts. This causes a temperature gradient between the honeycomb structure and the external cylinder, because the honeycomb structure is heated easier than the external cylinder due to its thermal capacity smaller than that of the external cylinder, and the external cylinder radiates heat larger than the honeycomb structure. This tendency causes similarly also in vehicle accelerating, showing a catalyst temperature profile similar to that when the engine starts.

On the other hand, a low-temperature exhaust gas has compositions close to the air and is supplied to the metal substrate during vehicle deceleration. Accordingly, the exhaust gas cools a central portion of the metal substrate more rapidly than its peripheral portion.

Such a temperature history concentrates a stress generated in the honeycomb structure particularly on a peripheral portion of the honeycomb structure joined with the external cylinder. The reason being that the peripheral portion is compressed due to restraint of the external cylinder on the honeycomb structure expanding outwardly with a temperature higher than that of the external cylinder when they are heated by the exhaust gas, while the peripheral portion is pulled by the external cylinder due to thermal contraction of the honeycomb structure when they are cooled.

In addition, thermal stress, in an axial direction of the honeycomb structure and the external cylinder, generates as shearing stress between them due to deformation difference between their thermal expansion and thermal contraction in the axial direction. Repeated compressive and tensile shearing stresses apply joining portions of the honeycomb structure and external cylinder, which cause easily thermal fatigue failure.

In order to avoid such a thermal fatigue failure, the contacting portions with which are not desirable to be joined, the upstream side contacting portions of the honeycomb structure and the external cylinder for example, are not diffusion-bonded.

These contacting portions are applied with a diffusion-bonding inhibitor, or heated after they are oxidation-treated so as to be free from being diffusion-bonded in a heat treatment process.

The diffusion bonding method of the fourth embodiment can provide a long life metal substrate, by preventing the contacting portions from being damaged due to the thermal fatigue failure.

While there have been particularly shown and described with reference to preferred embodiments thereof, it will be understood that various modifications may be made therein, and it is intended to cover in the appended claims all such modifications as fall within the true spirit and scope of the invention.

The honeycomb structure 1 may be formed by only stacking the long pitch corrugated plate 11 and the short pitch corrugated plate 12 with each other into multi-layers, without rolling them.

Although the honeycomb structure 1 is constituted of the long pitch corrugated plate 11 and the short pitch corrugated plate 12 in the embodiments, it may be formed of the long pitch corrugated plate 11 and a flat plate instead of the short pitch corrugated plate 12.

In order to form the honeycomb structure 1, the long pitch corrugated plate 11 may be located at the outside thereof to form a cylinder shape.

The numbers of the inlet port 31, 31a to 31c and the outlet port 32, 32a to 32c of the heat treatment furnace may be set arbitrary; two inlet ports and one outlet port for example.

The external cylinder 2 and honeycomb structure 1 may be formed to have an arbitrary shape in section.

Further, the heat treatment furnace 3 may have a plurality of inlet ports located over and along the external cylinder so that the inert gases G supplied through the inlet ports can flow along the external cylinder 2 and a peripheral portion of the honeycomb structure 1 in its axial direction. This can effectively blow off the nitrogen gas N by using a smaller amount of the inert gas G.

Continuously supplying of the inert gas of the present invention includes intermittent supplying when it can supply the inert gas substantially continuously.

The entire contents of Japanese Patent Application No. 2005-143505 filed May 17, 2005 are incorporated herein by reference.

1. A diffusion bonding method for forming a metal substrate having a honeycomb structure made of aluminum-containing stainless steel and a metal external cylinder containing the honeycomb structure, the honeycomb structure being formed by a first corrugated plate and one of a flat plate and a second corrugated plate in a pitch shorter than the first corrugated plate which are stacked on each other into multi-layers, the diffusion bonding metal comprising:
placing the metal substrate in a heat chamber of a heat treatment furnace;
supplying an inert gas into the heat chamber; and
heating the metal substrate at a diffusion bonding temperature, wherein
the inert gas is substantially kept being supplied to the heat chamber through an inlet port of the heat treatment furnace and discharged through an outlet port thereof during a heat treatment process so that the inert gas can blow off a nitrogen gas emitted from the external cylinder of the metal substrate.

2. The diffusion bonding method of claim 1, wherein
the inlet port and the outlet port are arranged in co-axial with each other.

3. The diffusion bonding method of claim 2, wherein
the inert gas is controlled so that a flow rate of the inert gas that passes through the inlet port and a pressure of a gas that passes through the outlet port to be constant, respectively.

4. The diffusion bonding method of claim 3, wherein
the inert gas that passes through one metal substrate is set to have a flow rate of no less than 1000 ml/min.

5. The diffusion bonding method of claim 4, wherein
part of contacting portions of the honeycomb structure and the external cylinder is free from diffusion bonding.

6. The diffusion bonding method of claim 5, wherein
the part of contacting portions is an upstream side portion.

7. The diffusion bonding method of claim 1, wherein
the inert gas is controlled so that a flow rate of the inert gas that passes through the inlet port and a pressure of a gas that passes through the outlet port to be constant, respectively.

8. The diffusion bonding method of claim 7, wherein
the inert gas that passes through one metal substrate is set to have a flow rate of no less than 1000 ml/min.

9. The diffusion bonding method of claim 8, wherein
part of contacting portions of the honeycomb structure and the external cylinder is free from diffusion bonding.

10. The diffusion bonding method of claim 9, wherein
the part of contacting portions is an upstream side portion.

11. The diffusion bonding method of claim 1, wherein
the inert gas that passes through one metal substrate is set to have a flow rate of no less than 1000 ml/min.

12. The diffusion bonding method of claim 1, wherein
part of contacting portions of the honeycomb structure and the external cylinder is free from diffusion bonding.

13. The diffusion bonding method of claim 12, wherein
the part of contacting portions is an upstream side portion.

14. The diffusion bonding method of claim 1, wherein
part of contacting portions of the honeycomb structure and the external cylinder is free from diffusion bonding.

15. The diffusion bonding method of claim 14, wherein
the part of contacting portions is an upstream side portion.
